(19) United States
(12) Patent Application Publication
(10) Pub. No.: US 2025/0355397 A1
(43) Pub. Date: Nov. 20, 2025

(54) IMAGE FORMING APPARATUS

(71) Applicant: FUJIFILM Business Innovation Corp., Tokyo (JP)

(72) Inventors: Misaki SURUGA, Kanagawa (JP); Jun KAWAI, Kanagawa (JP)

(73) Assignee: FUJIFILM Business Innovation Corp., Tokyo (JP)

(21) Appl. No.: 18/889,995

(22) Filed: Sep. 19, 2024

(30) Foreign Application Priority Data
May 17, 2024 (JP) 2024-080754

(51) Int. Cl. G03G 15/00; G03G 15/01; G03G 15/16

(52) U.S. Cl. CPC G03G 15/6564; G03G 15/0189; G03G 15/1605; G03G 15/657; G03G 2215/00409; G03G 2215/00413; G03G 2215/00447; G03G 2215/0132

(57) ABSTRACT

An image forming apparatus includes: a first image forming unit that includes plural first image forming sections and a first intermediate transfer member on which a toner image formed by the plural first image forming sections is primarily transferred; a second image forming unit that is provided on a downstream side of the first image forming unit in a paper transport direction and includes plural second image forming sections and a second intermediate transfer member on which a toner image formed by the plural second image forming sections is primarily transferred; a first secondary transfer section that is provided corresponding to the first image forming unit and secondarily transfers the toner image formed on the first intermediate transfer member onto paper transported on a paper transport path; a second secondary transfer section that is provided corresponding to the second image forming unit and secondarily transfers the toner image formed on the second intermediate transfer member onto paper transported on a paper transport path; and a paper position adjusting roll that transports fed paper, at a predetermined timing, to a first secondary transfer position at which the first secondary transfer section performs secondary transfer, in which a distance between the paper position adjusting roll and a second secondary transfer position at which the second secondary transfer section performs the secondary transfer is longer than a maximum paper length that is a transport-direction length of paper having a largest paper size among sheets of paper having a probability of being used.

### CROSS-REFERENCE TO RELATED APPLICATIONS

This application is based on and claims priority under 35 USC 119 from Japanese Patent Application No. 2024-080754 filed May 17, 2024.

### BACKGROUND

### (i) Technical Field

The present disclosure relates to an image forming apparatus.

### (ii) Related Art

JP1996-211673A discloses a printing apparatus in which a plurality of engine units are stacked and disposed in an up-down direction, and a common discharge and transport unit, a speed switching control unit, a high-speed rotation holding control unit, and a timing restriction unit are provided, the printing apparatus being configured so that the amount of printing data can be shared and printed by each engine unit, and printed paper discharged from each engine unit can be discharged to common paper receiver at a high speed by a transport unit of the printing apparatus or the common discharge and transport unit.

JP1997-325560A discloses an image forming apparatus in which a plurality of image forming units are arranged in parallel, for example, in a vertical direction, a toner image is sequentially transferred on a transfer material at a transfer portion of each image forming unit, each image forming unit is provided with a transport and transfer unit, and a distance between nip transport units on a transfer material transport path on an entrance side and an exit side is defined to be shorter than a transport-direction length of a transfer material having a standard use size, or a transfer material having a minimum use size is nipped across at least the transport and transfer units of the plurality of image forming units in a state where the transfer material is not simultaneously nipped by the nip transport units on the entrance side and the exit side.

### SUMMARY

In recent years, in order to expand a color gamut of an image formed by an image forming apparatus, an image is formed by using not only toners of basic colors such as CMYK but also toners of special colors other than CMYK. In such an image forming apparatus, a configuration in which a toner image is formed on paper by using two image forming units each including a plurality of image forming sections that form a toner image may be used. In each image forming unit, the toner image formed by the plurality of image forming sections is primarily transferred on an intermediate transfer member, and the toner image on the intermediate transfer member is secondarily transferred on the paper transported on a paper transport path. That is, in a case where a toner image is formed on paper by using two image forming units, secondary transfer is performed at two secondary transfer positions.

Aspects of non-limiting embodiments of the present disclosure relate to an image forming apparatus that is capable of preventing an occurrence of a situation in which a fluctuation in a transport speed in a case where paper passes by a paper position adjusting roll is simultaneously transmitted to two secondary transfer positions.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a first image forming unit that includes a plurality of first image forming sections and a first intermediate transfer member on which a toner image formed by the plurality of first image forming sections is primarily transferred; a second image forming unit that is provided on a downstream side of the first image forming unit in a paper transport direction and includes a plurality of second image forming sections and a second intermediate transfer member on which a toner image formed by the plurality of second image forming sections is primarily transferred; a first secondary transfer section that is provided corresponding to the first image forming unit and secondarily transfers the toner image formed on the first intermediate transfer member onto paper transported on a paper transport path; a second secondary transfer section that is provided corresponding to the second image forming unit and secondarily transfers the toner image formed on the second intermediate transfer member onto paper transported on a paper transport path; and a paper position adjusting roll that transports fed paper, at a predetermined timing, to a first secondary transfer position at which the first secondary transfer section performs secondary transfer, in which a distance between the paper position adjusting roll and a second secondary transfer position at which the second secondary transfer section performs the secondary transfer is longer than a maximum paper length that is a transport-direction length of paper having a largest paper size among sheets of paper having a probability of being used.

### BRIEF DESCRIPTION OF THE DRAWINGS

Exemplary embodiment(s) of the present invention will be described in detail based on the following figures, wherein:

FIG. 1 is a diagram showing a configuration of an image forming apparatus 10 according to an exemplary embodiment of the present disclosure;

FIG. 2 is a diagram for describing configurations of image forming sections 32P, 32S, 32G, and 32Gr, and configurations of image forming sections 52Y, 52M, 52C, and 52K;

FIG. 3 is a diagram for describing a configuration of a control device 80 that controls an operation of the image forming apparatus 10;

FIG. 4 is a diagram for describing a mechanism in which a misalignment occurs in a case where a speed fluctuation of paper PP is simultaneously transmitted to two secondary transfer positions TJ2 and TK2;

FIGS. 5A and 5B are diagrams showing examples of the misalignment between respective colors, which occurs at the two secondary transfer positions TJ2 and TK2;

FIG. 6 is a diagram showing a positional relationship between a registration roll 15 and the secondary transfer position TK2;

FIG. 7 is a diagram showing a positional relationship between a fixing roll 16 and the secondary transfer position TJ2;

FIG. 8 is a diagram showing a positional relationship between the registration roll 15 and the secondary transfer position TJ2; and

FIG. 9 is a diagram showing a configuration example in a case where a paper feeding device 100 is added to the image forming apparatus 10.

### DETAILED DESCRIPTION

Hereinafter, an exemplary embodiment of the present disclosure will be described in detail with reference to the drawings.

### Image Forming Apparatus

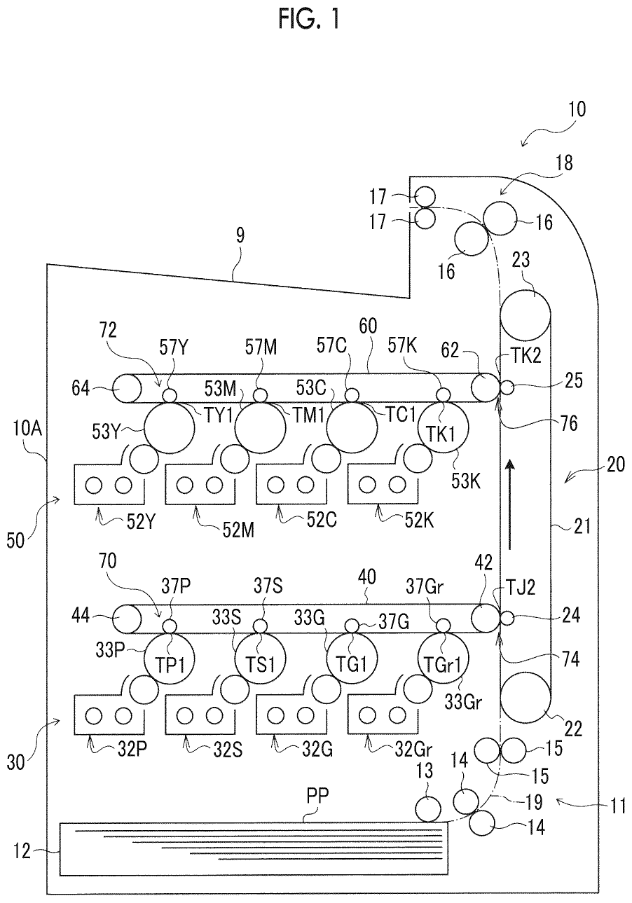

FIG. 1 is a diagram showing a configuration of an image forming apparatus 10 according to an exemplary embodiment of the present disclosure.

As shown in FIG. 1, the image forming apparatus 10 includes a paper storage section 12 in which paper PP is accommodated, a transport section 11 that transports the paper PP along a transport path 19, an image forming unit 30 and an image forming unit 50 that form a toner image to be transferred to the paper PP.

The paper storage section 12 can be pulled out from the image forming apparatus main body 10A, which is the apparatus main body of the image forming apparatus 10, and accommodates the paper PP.

The transport section 11 includes a sending roll 13, a paper feeding roll 14, a registration roll 15, a transport device 20, a fixing section 18, a discharge roll 17, and the like in order from the upstream side in a transport direction.

The sending roll 13 sends the paper PP stored in the paper storage section 12 to the transport path 19 constituting the transport section 11. The paper feeding rolls 14 feed the paper PP stored in the paper storage section 12 to the registration roll 15 along the transport path 19.

The registration rolls 15 increase the transport speed of the paper PP fed by the paper feeding roll 14 and transport the paper PP to a secondary transfer position TJ2 which will be described later. The registration rolls 15 sandwich the paper PP and transport the paper PP to a downstream side in the transport direction. As described above, the registration rolls 15 are paper position adjusting rolls that transport the paper PP fed from the paper storage section 12 to the secondary transfer position TJ2 at which a secondary transfer section 74 performs secondary transfer, at a predetermined timing.

The transport device 20 transports the paper PP to the downstream side in the transport direction along the transport path 19 while transferring a toner image formed by the image forming units 30 and 50 to the paper PP. Details of the transport device 20 will be described later.

The fixing section 18 includes two fixing rolls 16, and fixes the toner image to the paper PP by heating and pressurizing the paper PP on which the toner image is transferred, in a case where the paper PP passes between the two fixing rolls 16. A position at which the toner image is fixed to the paper PP by the two fixing rolls 16 is referred to as a fixing position.

The discharge roll 17 discharges the paper PP on which the toner image is fixed by the fixing section 18 to a discharge section 9.

The image forming unit 30 and the image forming unit 50 are arranged in the up-down direction. In the present exemplary embodiment, the image forming unit 50 is disposed above the image forming unit 30. From another point of view, the image forming unit 50 is disposed on the downstream side in the paper transport direction of the image forming unit 30.

In the image forming unit 50, toner images of basic colors of yellow (Y), magenta (M), cyan (C), and black (K) are formed.

In the image forming unit 30, a toner image of a special color other than the basic colors is formed. The image forming unit 30 includes four image forming sections 32 and an endless intermediate transfer belt 40. The intermediate transfer belt 40 is mounted such that the toner images formed by the four image forming sections 32 are transferred, and the intermediate transfer belt 40 is rotatable counterclockwise in front view of FIG. 1.

The image forming section 32 includes an image forming section 32P that forms a toner image of a fluorescent pink color (P), an image forming section 32S that forms a toner image of a silver color(S), an image forming section 32G that forms a toner image of a gold color (G), and an image forming section 32Gr that forms a toner image of a fluorescent green color (Gr). The four image forming sections 32 are disposed in the order of the image forming section 32P, the image forming section 32S, the image forming section 32G, and the image forming section 32Gr in order from the upstream side in a rotation direction (the side close to a support roll 44 to be described later) in which the intermediate transfer belt 40 rotates. The image forming sections 32P, 32S, 32G, and 32Gr includes photoconductors 33P, 32S, 32G, and 32Gr, respectively.

In a case where it is not necessary to distinguish between P, S, G, and Gr, P, S, G, and Gr are omitted.

In addition, primary transfer rolls 37P, 37S, 37G, and 37Gr that transfer the toner image formed by the image forming section 32 to the intermediate transfer belt 40 are disposed at positions facing each photoconductor 33 with the intermediate transfer belt 40 interposed therebetween. The intermediate transfer belt 40 is wound around the support roll 44 that supports the intermediate transfer belt 40 and a backup roll 42 disposed in the secondary transfer section 74 on the upstream side, which will be described later. A primary transfer section 70 is configured to include the photoconductor 33, the primary transfer rolls 37, and the intermediate transfer belt 40. In addition, primary transfer positions TP1, TS1, TG1, and TGr1 are set between the photoconductors 33P, 33S, 33G, and 33Gr, and the intermediate transfer belt 40, respectively.

The image forming unit 50 has the similar configuration to the above-described image forming unit 30 except that colors for forming an image are different.

The image forming unit 50 includes four image forming sections 52 and an intermediate transfer belt 60. The intermediate transfer belt 60 is mounted such that the toner images formed by the four image forming sections 52 are transferred, and the intermediate transfer belt 60 is rotatable counterclockwise in front view of FIG. 1.

The image forming section 52 has the similar configuration to the image forming section 32 of the image forming unit 30 except that colors for forming an image are different. Further, the intermediate transfer belt 60 and the primary transfer roll 57 described later have the similar configuration to the intermediate transfer belt 40 and the primary transfer roll 37 of the image forming unit 30. Further, the other constituent members constituting the image forming unit 50 are similar to the constituent members of the image forming unit 30.

The image forming section 52 includes an image forming section 52Y that forms a toner image of a yellow color, an image forming section 52M that forms a toner image of a magenta color, an image forming section 52C that forms a toner image of a cyan color, and an image forming section 52K that forms a toner image of a black color. The four image forming sections 52 are disposed in the order of the image forming section 52Y, the image forming section 52M, the image forming section 52C, and the image forming section 52K in order from the rotation direction upstream side (the side closer to a support roll 64 to be described later). That is, in the image forming section 52, the image forming section 52K is disposed on the most downstream side in the rotation direction. The image forming sections 52Y, 52M, 52C, and 52K include photoconductors 53Y, 53M, 53C, or 53K, respectively.

In a case where it is not necessary to distinguish between Y, M, C, and K, Y, M, C, and K are omitted.

Further, the primary transfer rolls 57Y, 57M, 57C, and 57K are disposed at positions facing respective photoconductors 53 with the intermediate transfer belt 60 interposed therebetween. The intermediate transfer belt 60 is wound around the support roll 64 and a backup roll 62 disposed in a secondary transfer section 76 on the downstream side, which will be described later. A primary transfer section 72 is configured to include the photoconductor 53, the primary transfer rolls 57, and the intermediate transfer belt 60. Further, primary transfer positions TY1, TM1, TC1, and TK1 are set between the photoconductors 53Y, 53M, 53C, and 53K and the intermediate transfer belt 60, respectively.

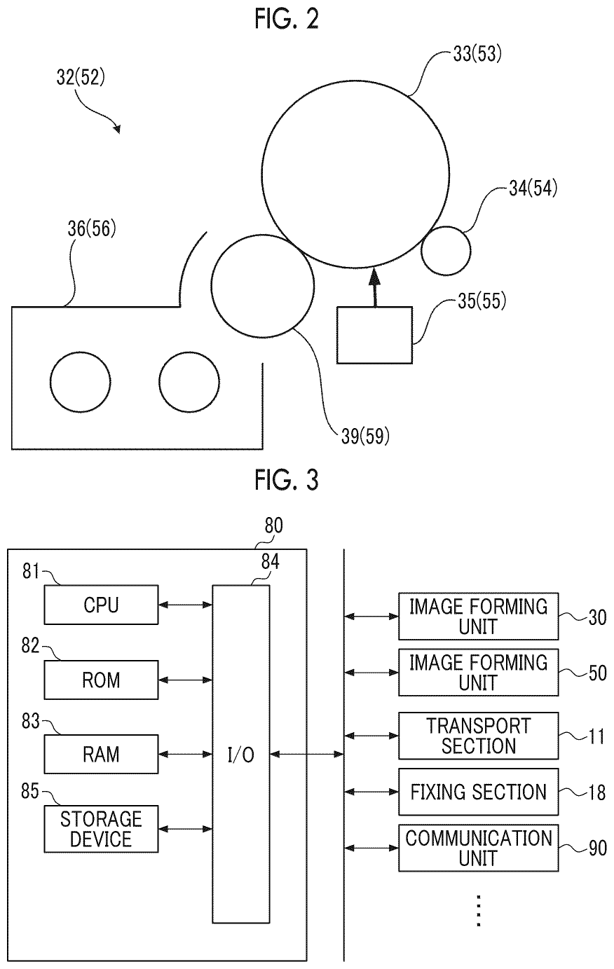

Next, the configurations of the image forming sections 32P, 32S, 32G, and 32Gr will be described with reference to FIG. 2. In addition, the configurations of the image forming sections 52Y, 52M, 52C, and 52K in the image forming unit 50 will be described together.

As shown in FIG. 2, the image forming section 32 includes the photoconductor 33, a charging member 34 that charges the surface of the photoconductor 33, an exposure device 35 that irradiates the charged photoconductor 33 with exposure light, and a developing device 36 that develops an electrostatic latent image formed by the irradiation with the exposure light to be visualized as a toner image. The developing device 36 includes a developing roll 39, and a developing bias is applied.

Similarly, as shown in FIG. 2, the image forming section 52 includes the photoconductor 53, a charging member 54, an exposure device 55, and a developing device 56. The developing device 56 includes a developing roll 59, and a developing bias is applied.

Next, the transport device 20 will be described in detail.

As shown in FIG. 1, the transport device 20 includes an endless transport belt 21, support rolls 22 and 23 that support the transport belt 21, and secondary transfer rolls 24 and 25 that are disposed at positions facing the backup rolls 42 and 62 with the intermediate transfer belts 40 and 60 interposed between the backup rolls 42 and 62, and the secondary transfer rolls 24 and 25.

The secondary transfer roll 24 sandwiches the paper PP and the transport belt 21 between the secondary transfer roll 24 and the backup roll 42, and transfers the toner image formed on the intermediate transfer belt 40 of the image forming unit 30 to the paper PP. Similarly, the secondary transfer roll 25 sandwiches the paper PP and the transport belt 21 between the secondary transfer roll 25 and the backup roll 62, and transfers the toner image formed on the intermediate transfer belt 60 of the image forming unit 50 to the paper PP.

The secondary transfer section 74 is configured to include the backup roll 42, the secondary transfer roll 24, and the intermediate transfer belt 40. Further, the secondary transfer section 76 is configured to include the backup roll 62, the secondary transfer roll 25, and the intermediate transfer belt 60.

A transfer bias is applied to each of the secondary transfer rolls 24 and 25.

In addition, the secondary transfer position TJ2 is defined between the intermediate transfer belt 40 of the image forming unit 30 and the transport belt 21, and the secondary transfer position TK2 is defined between the intermediate transfer belt 60 of the image forming unit 50 and the transport belt 21. The secondary transfer position TK2 is the most downstream secondary transfer position.

As described above, the image forming unit 30 includes the four image forming sections 33P, 33S, 33G, and 33Gr, and the intermediate transfer belt 40 on which a toner image formed by the four image forming sections 33 is primarily transferred. Then, the image forming unit 50 is provided on a downstream side of the image forming unit 30 in the paper transport direction, and includes the four image forming sections 53Y, 53M, 53C, and 53K and the intermediate transfer belt 60 on which a toner image formed by the four image forming sections 53 is primarily transferred. Then, the secondary transfer section 74 is provided corresponding to the image forming unit 30, and secondarily transfers the toner image formed on the intermediate transfer belt 40 onto the paper PP transported on the paper transport path. In addition, the secondary transfer section 76 is provided corresponding to the image forming unit 50, and secondarily transfers the toner image formed on the intermediate transfer belt 60 onto the paper PP transported on the paper transport path.

### Control Device

Next, the control device 80 that controls the operation of the image forming apparatus 10 will be described with reference to FIG. 3.

As shown in FIG. 3, the image forming unit 30, the image forming unit 50, the transport section 11, a communication unit 90, and the like are electrically connected to the control device 80.

As shown in FIG. 3, the control device 80 includes a central processing unit (CPU) 81, a read only memory (ROM) 82, a random access memory (RAM) 83, a storage device 85 such as a hard disk drive, and an input and output interface (abbreviated as I/O) 84 that performs input and output of data to and from each device via a network. These components are connected to each other via a control bus.

Here, the ROM 82 stores an image formation control program (not shown) to be executed by the CPU 81. Then, the CPU 81 reads the image formation control program (not shown) from the ROM 82 and expands the image formation control program into the RAM 83 to execute a printing process by the image formation control program (not shown).

In addition, the image forming unit 30, the image forming unit 50, the transport section 11, the communication unit 90, and the like are connected to the I/O 84. The communication unit 90 is an interface for performing data communication between a terminal device such as a personal computer and the image forming apparatus 10.

The control device 80 performs various controls for forming a toner image on the intermediate transfer belt 40 by the image forming section 32 of each color in the image forming unit 30. Similarly, the control device 80 performs various controls for forming a toner image on the intermediate transfer belt 60 by the image forming section 52 of each color in the image forming unit 50.

In addition, the control device 80 controls developing biases applied to the developing rolls 39 and 59 of the developing devices 36 and 56, respectively. Further, the control device 80 controls transfer biases applied to the secondary transfer rolls 24 and 25, respectively.

In addition, the control device 80 controls the supply timing, the supply time, the supply amount, and the like of the toner supply of each color toner from a toner cartridge of each color to the developing devices 36 and 56.

### Image Forming Process

Next, the outline of an image forming process in the image forming apparatus 10 will be described.

First, the control device 80 controls each image forming section 32 such that a toner image is formed on the intermediate transfer belt 40 of the image forming unit 30. Similarly, the control device 80 controls each image forming section 52 such that a toner image is formed on the intermediate transfer belt 60 of the image forming unit 50.

Specifically, the control device 80 applies a voltage to the charging members 34 and 54, and charges the surfaces of the photoconductors 33 and 53 to have a predetermined potential, by using the charging members 34 and 54 to which a voltage is applied. Subsequently, the control device 80 irradiates the surfaces of the photoconductors 33 and 53 charged by the charging members 34 and 54 with exposure light by the exposure devices 35 and 55 to form an electrostatic latent image, based on image data acquired through the communication unit 90. Thus, an electrostatic latent image corresponding to the image data is formed on the surfaces of the photoconductors 33 and 53.

Then, the control device 80 develops the electrostatic latent image formed by the exposure devices 35 and 55 by the developing devices 36 and 56 and visualizes the electrostatic latent image as a toner image. Further, the control device 80 superimposes and transfers the toner image formed on the surfaces of the photoconductors 33 and 53 of each color on the intermediate transfer belts 40 and 60, by the primary transfer rolls 37 and 57.

In this manner, a toner image obtained by superimposing toners of, for example, a fluorescent pink color (P), a silver color(S), a gold color (G), and a fluorescent green color (Gr) is formed on the intermediate transfer belt 40 in the image forming unit 30. Similarly, a toner image obtained by superimposing toners of, for example, yellow (Y), magenta (M), cyan (C), and black (K) is formed on the intermediate transfer belt 60 in the image forming unit 50.

Here, the paper PP sent from the paper storage section 12 to the transport path 19 by the sending roll 13 is sent to the secondary transfer position TJ2 after the transport timing is adjusted by the two registration rolls 15 based on the control of the control device 80. At the secondary transfer position TJ2, the paper PP is transported between the backup roll 42 and the secondary transfer roll 24, so that the toner image on the outer peripheral surface of the intermediate transfer belt 40 is transferred to the paper PP. Then, the paper PP on which the toner image is transferred is transported to the downstream side in the transport direction and reaches the secondary transfer position TK2 on the downstream side in the transport direction.

At this time, the control device 80 adjusts the timing to start image formation such that the toner image formed on the intermediate transfer belt 60 of the image forming unit 50 is superimposed and transferred on the toner image on the paper PP transported from the upstream side in the transport direction.

The paper PP, on which the toner images of the respective colors formed by the image forming unit 30 and the image forming unit 50 are superimposed and transferred, is fixed by the fixing roll 16 of the fixing section 18, and then is discharged to the discharge section 9 provided at the upper portion of an image forming apparatus main body 10A, by the discharge roll 17.

With the above-described configuration, in the image forming apparatus 10 according to the present exemplary embodiment, it is possible to form an image by using a toner of a special color other than CMYK in addition to the toner of the basic color of CMYK colors. In such an image forming apparatus 10, the configuration in which a toner image is formed on paper by using the two image forming units 30 and 50 each including a plurality of image forming sections 32 and 52 that form a toner image is used. In each of the image forming units 30 and 50, the toner image formed by the plurality of image forming sections 32 and 52 is primarily transferred onto the intermediate transfer belts 40 and 60 that are the intermediate transfer members, and the toner image on the intermediate transfer belts 40 and 60 is secondarily transferred onto paper PP transported by the transport device 20. That is, in a case where a toner image is formed on paper by using the two image forming units 30 and 50, secondary transfer is performed at the two secondary transfer positions TJ2 and TK2.

Here, the paper PP to be transported to the secondary transfer positions TJ2 and TK2 needs to be transported at a predetermined timing synchronized with the image formation timing. Therefore, the paper transported by the paper feeding roll 14 is transported to the secondary transfer positions TJ2 and TK2 by adjusting the transport timing by the paper position adjusting roll called the registration roll 15. Then, in a case where the transport speed by the paper feeding roll 14 and the transport speed by the registration roll 15 are different from each other, the fluctuation in the transport speed occurs in a case where the paper PP passes by the paper feeding roll 14 and the registration roll 15.

However, in a case where the fluctuation in the transport speed of the paper PP occurs in a state where the secondary transfer is performed on the paper at the two secondary transfer positions TJ2 and TK2, the fluctuation in the transport speed is simultaneously transmitted to the two secondary transfer positions TJ2 and TK2. Then, the fluctuation in the transport speed is simultaneously transmitted to the plurality of image forming sections 32 and 52 via the intermediate transfer belts 40 and 60 of the two image forming units 30 and 50, respectively. As a result, image formation in the plurality of image forming sections 32 and 52 is influenced, and thus there is a possibility that the misalignment occurs in the formed image.

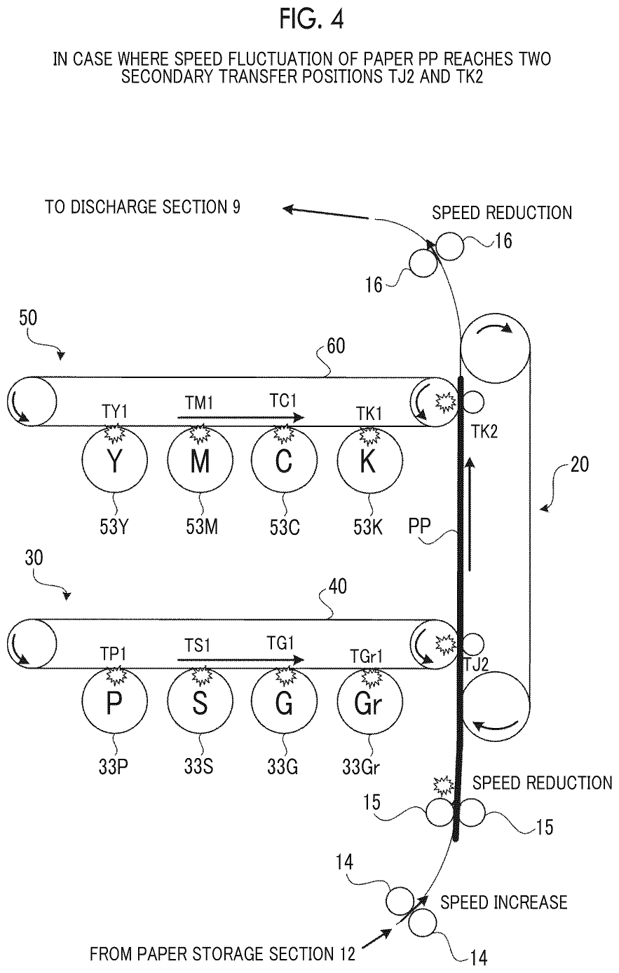

A mechanism in which the misalignment occurs in a case where the speed fluctuation of the paper PP is simultaneously transmitted to the two secondary transfer positions TJ2 and TK2 will be described with reference to FIG. 4. It is assumed that, in FIG. 4, among structures constituting the image forming apparatus 10, only structures necessary for the description are shown, and other structures are omitted. The same applies to the drawings in the following description.

The paper PP sent from the paper storage section 12 is transported to the registration roll 15 in a state where the transport speed is increased by the paper feeding roll 14. However, the registration roll 15 transports the paper PP that has been transported, to the secondary transfer position TJ2 of the transport device 20 at a predetermined transport timing. The registration roll 15 is set to have a transport speed slightly faster than the paper feeding roll 14.

However, the transport speed at the secondary transfer position TJ2 is set to be slower than the transport speed of the registration roll 15. Therefore, in a case where the paper PP passes by the registration roll 15, the paper PP is transported to the secondary transfer position TJ2 in a state where the transport speed of the paper PP is reduced.

As described above, the fluctuation in the transport speed occurs in a case where the paper PP is added with the registration roll 15. Therefore, in a case where the paper PP reaches the two secondary transfer positions TJ2 and TK2 in a state where the paper PP is still passing by the registration roll 15, the speed fluctuation of the paper PP is transmitted from the two secondary transfer positions TJ2 and TK2 to the intermediate transfer belts 40 and 60, respectively. As a result, the fluctuation in the transport speed is also transmitted to the primary transfer positions TP1, TS1, TG1, TGr1, TY1, TM1, TC1, and TK1 in the image forming units 30 and 50. Therefore, the speed fluctuation is also transmitted to the photoconductors 33P, 33S, 33G, 33Gr, 53Y, 53M, 53C, and 53K, and the misalignment occurs at the overlapping positions of the toner images of the respective colors. Further, since the timings at which the secondary transfer is performed at the two secondary transfer positions TJ2 and TK2 are different from each other, the different colors at the two secondary transfer positions TJ2 and TK2 cause the misalignment.

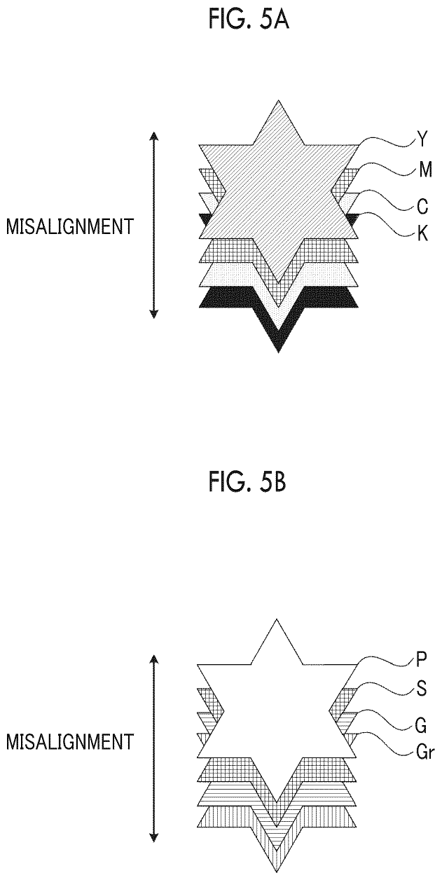

FIGS. 5A and 5B show examples of the misalignment between the colors, which occurs in this manner. FIG. 5A is a diagram showing a form in which the misalignment occurs between the YMCK colors. In addition, FIG. 5B is a diagram showing a form in which the misalignment occurs between the PSGGr colors that are special colors. Referring to FIGS. 5A and 5B, it can be understood that the misalignment occurs in the overlapping of the respective colors by the transmission of the speed fluctuation to the photoconductors 33P, 33S, 33G, 33Gr, 53Y, 53M, 53C, and 53K via the intermediate transfer belts 40 and 60.

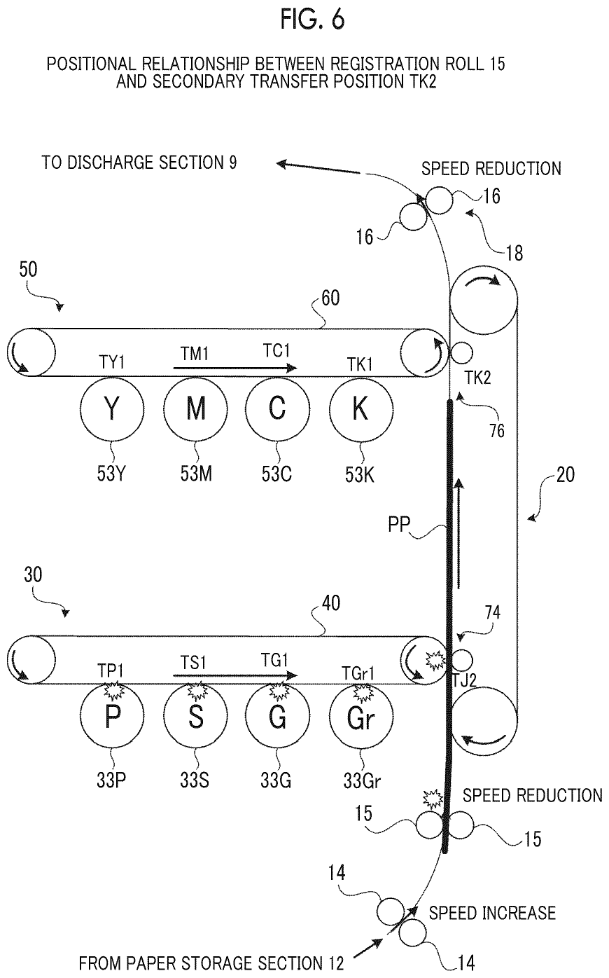

Therefore, in the image forming apparatus 10 in the present exemplary embodiment, the configuration as shown in FIG. 6 is adopted to prevent an occurrence of a situation in which the fluctuation in the transport speed in a case where the paper PP passes by the registration roll 15 is simultaneously transmitted to the two secondary transfer positions TJ2 and TK2. FIG. 6 is a diagram showing a positional relationship between the registration roll 15 and the secondary transfer position TK2.

As can be understood with reference to FIG. 6, the configuration is made such that a distance between the registration roll 15 that is the paper position adjusting roll and the secondary transfer position TK2 at which the secondary transfer section 76 performs the secondary transfer is longer than the maximum paper length that is the transport-direction length of paper having the largest paper size among sheets of paper that may be used.

For example, it is assumed that the paper having the largest paper size among the sheets of paper that may be used is paper having an A4 size (210 mm×297 mm). In this case, the transport-direction length of the A4-size paper is 297 mm, and thus the maximum paper length is also 297 mm. As a result, in this case, the positional relationship between the image forming unit 50 and the registration roll 15 is set such that the distance between the registration roll 15 and the secondary transfer position TK2 is equal to or more than 297 mm. The paper PP in FIG. 6 indicates a case in which the paper size is A4 size.

With such a configuration, with reference to FIG. 6, the leading end of the paper PP does not reach the secondary transfer position TK2 during a state where the paper PP is sandwiched between the registration rolls 15.

Therefore, the speed fluctuation occurring in a case where the paper PP passes by the registration roll 15 is not transmitted to the secondary transfer position TK2. As a result, the speed fluctuation is not transmitted to the photoconductors 53Y, 53M, 53C, and 53K in the image forming unit 50.

That is, by preventing the occurrence of a situation in which the speed fluctuation of the paper PP in a case where the paper PP passes by the registration roll 15 is simultaneously transmitted to the two secondary transfer positions TJ2 and TK2, the misalignment between the colors of the toner image formed in the image forming unit 50 is suppressed.

Even with the above-described configuration, the speed fluctuation occurring in a case where the paper PP passes by the registration roll 15 is transmitted to the secondary transfer position TJ2. However, there is a technique of correcting the misalignment between colors by performing image processing on image data for forming the toner image to correct the positions of the toner image of the respective colors. By using such a technique, it is possible to correct the misalignment occurring in one region on the paper. However, it is difficult to correct the misalignment occurring in two or more regions on the paper even by using such a technique. Therefore, in a case where the speed fluctuation occurring in a case where the paper PP passes by the registration roll 15 is simultaneously transmitted to the two secondary transfer positions TJ2 and TK2, and thus the misalignment occurs in two regions on the paper, it is difficult to correct the misalignment.

That is, by limiting the secondary transfer position at which the speed fluctuation occurring in a case where the paper PP passes by the registration roll 15 is transmitted to one place, it is possible to suppress the misalignment between the colors, which occurs on the paper.

Further, as shown in FIG. 4, in a case where the leading end of the paper PP reaches the secondary transfer position TK2 before the paper PP passes by the registration roll 15, the paper PP is pressed at three positions of the registration roll 15, the secondary transfer position TJ2, and the secondary transfer position TK2. Therefore, in a case where the speed fluctuation occurring in a case where the paper PP passes by the registration roll 15 is transmitted to the two secondary transfer positions TJ2 and TK2, it is difficult to predict what kind of the misalignment occurs due to the interaction between the two secondary transfer positions TJ2 and TK2. Therefore, in a case where the speed fluctuation occurring in a case where the paper PP passes by the registration roll 15 is simultaneously transmitted to the two secondary transfer positions TJ2 and TK2, it is difficult to correct the misalignment as compared with a case where the speed fluctuation is transmitted to only one secondary transfer position TJ2.

The fixing section 18 fixes the toner image on the paper after the secondary transfer section 76 performs the secondary transfer, to the paper PP. In this case, the fixing section 18 fixes the toner image to the paper PP in a state where the transport speed of the paper PP transported on the paper transport path is reduced at the fixing position.

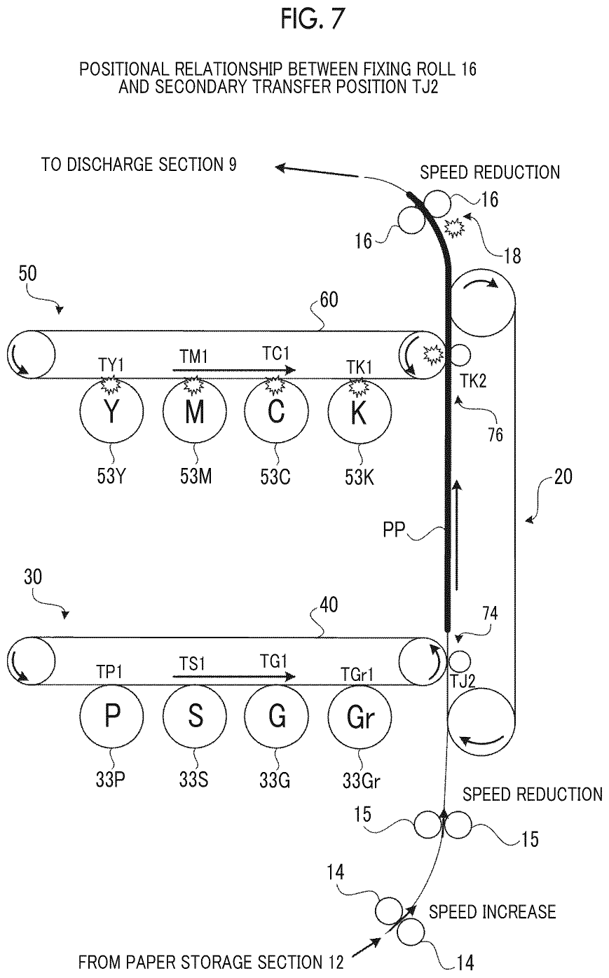

As described above, since the speed fluctuation also occurs in the fixing section 18, as shown in FIG. 7, the image forming apparatus 10 in the present exemplary embodiment is configured such that the distance between the fixing position at which the fixing section 18 fixes the toner image to the paper and the secondary transfer position TJ2 at which the secondary transfer section 74 performs the secondary transfer is longer than the maximum paper length. FIG. 7 is a diagram showing a positional relationship between the fixing roll 16 of the fixing section 18 and the secondary transfer position TJ2.

With reference to FIG. 7, it can be understood that, with such a configuration, the occurrence of a situation in which the speed fluctuation occurring in a case where the paper PP passes through the fixing section 18 is simultaneously transmitted to the two secondary transfer positions TJ2 and TK2 is prevented.

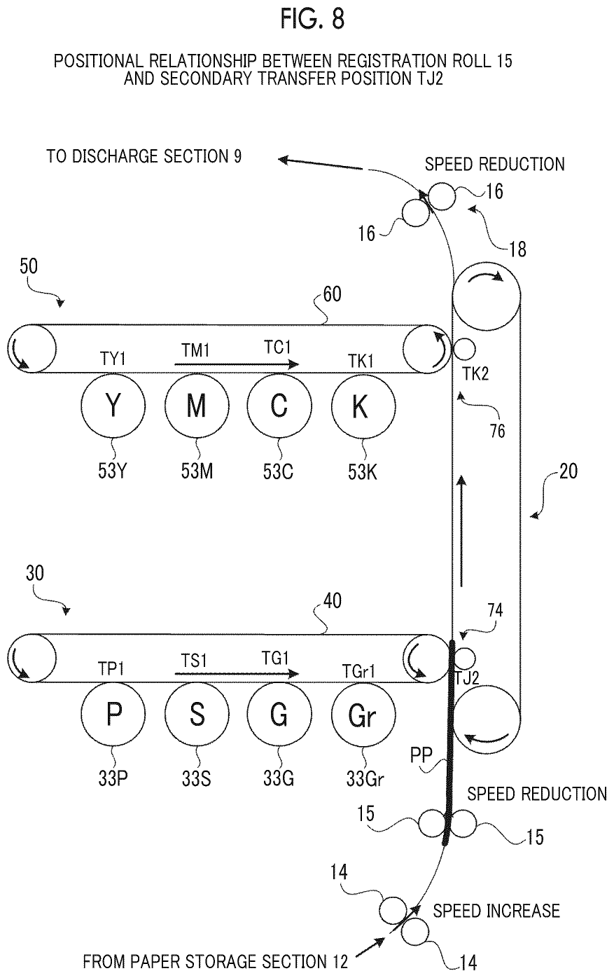

Next, FIG. 8 shows a positional relationship between the registration roll 15 and the secondary transfer position TJ2. In a case where the position of the registration roll 15 is set to be too low in an attempt to increase the distance between the registration roll 15 and the secondary transfer position TK2, the distance between the registration roll 15 and the secondary transfer position TJ2 is increased. Then, in a case where the distance between the registration roll 15 and the secondary transfer position TJ2 is too long, and the paper PP having a short paper length is intended to be transported, the paper PP may fall off between the registration roll 15 and the secondary transfer position TJ2.

Therefore, in the image forming apparatus 10 in the present exemplary embodiment, the distance between the registration roll 15 and the secondary transfer position TJ2 at which the secondary transfer section 74 performs the secondary transfer is set to be shorter than the minimum paper length that is the transport-direction length of the paper having the smallest paper size among sheets of paper that may be used.

For example, it is assumed that the paper having the smallest paper size among the sheets of paper that may be used is paper having a L-size photographic size (89 mm×127 mm). In this case, since the transport-direction length of the paper having the L-size photographic size is 127 mm, the minimum paper length is also 127 mm. As a result, in this case, the positional relationship between the image forming unit 30 and the registration roll 15 is set such that the distance between the registration roll 15 and the secondary transfer position TJ2 is equal to or shorter than 127 mm. The paper PP in FIG. 8 indicates a case in which the paper size is the L-size photographic size.

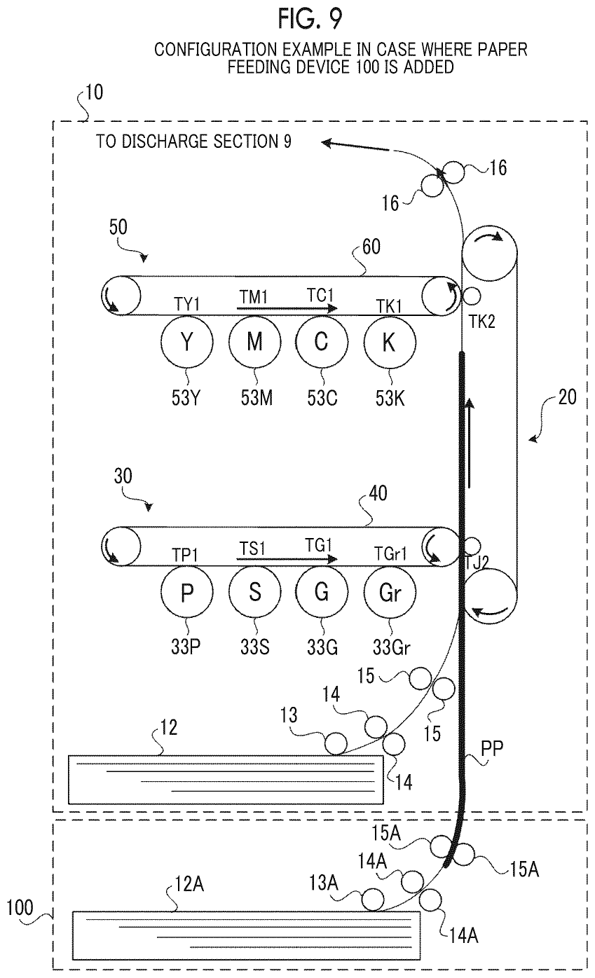

Next, FIG. 9 shows a configuration example in a case where a paper feeding device 100 is added to the image forming apparatus 10.

The paper feeding device 100 can be set as an option after the image forming apparatus 10. The paper feeding device 100 includes a paper storage section 12A, a sending roll 13A, a paper feeding roll 14A, and a registration roll 15A. As described above, in the configuration in which the paper feeding device 100 is added to the image forming apparatus 10, a configuration in which two paper storage sections 12 and 12A that store a plurality of sheets of paper having different paper sizes, and a plurality of registration rolls 15 and 15A corresponding to the two paper storage sections 12 and 12A are provided is made.

In a case where paper is fed to the image forming apparatus 10 by using such an added paper feeding device 100, paper having a larger paper size is set to be stored in the paper storage section having a longer distance to the secondary transfer position TJ2 among the plurality of paper storage sections 12 and 12A. By performing setting in this manner, in a case where a plurality of sheets of paper having different paper sizes are used, the distance between the registration roll and the secondary transfer position TJ2 can be set to be longer than the maximum paper length.

For example, in a case where paper having the A3 size is set to be stored in the paper storage section 12A on the paper feeding device 100 side, it is easy to set the distance between the registration roll 15A and the secondary transfer position TJ2 to be longer than the length of the A3-size paper in the transport direction.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in the present exemplary embodiment includes both a system configured by a plurality of devices and a system configured by a single device.

### Supplementary Notes

Supplementary notes of the aspects of the present disclosure will be described below.
(((1)))

An image forming apparatus comprising:
a first image forming unit that includes a plurality of first image forming sections and a first intermediate transfer member on which a toner image formed by the plurality of first image forming sections is primarily transferred;
a second image forming unit that is provided on a downstream side of the first image forming unit in a paper transport direction and includes a plurality of second image forming sections and a second intermediate transfer member on which a toner image formed by the plurality of second image forming sections is primarily transferred;
a first secondary transfer section that is provided corresponding to the first image forming unit and secondarily transfers the toner image formed on the first intermediate transfer member onto paper transported on a paper transport path;
a second secondary transfer section that is provided corresponding to the second image forming unit and secondarily transfers the toner image formed on the second intermediate transfer member onto paper transported on a paper transport path; and
a paper position adjusting roll that transports fed paper, at a predetermined timing, to a first secondary transfer position at which the first secondary transfer section performs secondary transfer,
wherein a distance between the paper position adjusting roll and a second secondary transfer position at which the second secondary transfer section performs the secondary transfer is longer than a maximum paper length that is a transport-direction length of paper having a largest paper size among sheets of paper having a probability of being used.
(((2)))

The image forming apparatus according to (((1))), further comprising:
a fixing section that fixes, to paper, a toner image on paper after the secondary transfer by the second secondary transfer section,
wherein a distance between a fixing position at which the fixing section fixes the toner image to the paper and the first secondary transfer position at which the first secondary transfer section performs the secondary transfer is longer than the maximum paper length.
(((3)))

The image forming apparatus according to (((2))),
wherein the fixing section fixes the toner image on the paper in a state where a transport speed of the paper transported on the paper transport path is reduced at the fixing position.
(((4)))

The image forming apparatus according to any one of (((1))) to (((3))),
wherein a distance between the paper position adjusting roll and the first secondary transfer position at which the first secondary transfer section performs the secondary transfer is shorter than a minimum paper length that is a transport-direction length of paper having a smallest paper size among the sheets of paper having a probability of being used.
(((5)))

The image forming apparatus according to (((4))), further comprising:
a paper feeding roll that feeds paper stored in a paper storage section to the paper position adjusting roll,
wherein the paper position adjusting roll increases a transport speed of the paper fed by the paper feeding roll and transports the paper to the first secondary transfer position.
(((6)))

The image forming apparatus according to any one of (((1))) to (((5))), further comprising:
a plurality of paper storage sections that store a plurality of sheets of papers having different paper sizes, respectively; and
a plurality of paper position adjusting rolls corresponding to the plurality of paper storage sections,
wherein paper having a larger paper size is set to be stored in a paper storage section having a longer distance to the first secondary transfer position among the plurality of paper storage sections.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first image forming unit that includes a plurality of first image forming sections and a first intermediate transfer member on which a toner image formed by the plurality of first image forming sections is primarily transferred;
a second image forming unit that is provided on a downstream side of the first image forming unit in a paper transport direction and includes a plurality of second image forming sections and a second intermediate transfer member on which a toner image formed by the plurality of second image forming sections is primarily transferred;
a first secondary transfer section that is provided corresponding to the first image forming unit and secondarily transfers the toner image formed on the first intermediate transfer member onto paper transported on a paper transport path;
a second secondary transfer section that is provided corresponding to the second image forming unit and secondarily transfers the toner image formed on the second intermediate transfer member onto paper transported on a paper transport path; and
a paper position adjusting roll that transports fed paper, at a predetermined timing, to a first secondary transfer position at which the first secondary transfer section performs secondary transfer,
wherein a distance between the paper position adjusting roll and a second secondary transfer position at which the second secondary transfer section performs the secondary transfer is longer than a maximum paper length that is a transport-direction length of paper having a largest paper size among sheets of paper having a probability of being used.

2. The image forming apparatus according to claim 1, further comprising:
a fixing section that fixes, to paper, a toner image on paper after the secondary transfer by the second secondary transfer section,
wherein a distance between a fixing position at which the fixing section fixes the toner image to the paper and the first secondary transfer position at which the first secondary transfer section performs the secondary transfer is longer than the maximum paper length.

3. The image forming apparatus according to claim 2,
wherein the fixing section fixes the toner image on the paper in a state where a transport speed of the paper transported on the paper transport path is reduced at the fixing position.

4. The image forming apparatus according to claim 1,
wherein a distance between the paper position adjusting roll and the first secondary transfer position at which the first secondary transfer section performs the secondary transfer is shorter than a minimum paper length that is a transport-direction length of paper having a smallest paper size among the sheets of paper having a probability of being used.

5. The image forming apparatus according to claim 4, further comprising:
a paper feeding roll that feeds paper stored in a paper storage section to the paper position adjusting roll,
wherein the paper position adjusting roll increases a transport speed of the paper fed by the paper feeding roll and transports the paper to the first secondary transfer position.

6. The image forming apparatus according to claim 1, further comprising:
a plurality of paper storage sections that store a plurality of sheets of papers having different paper sizes, respectively; and
a plurality of paper position adjusting rolls corresponding to the plurality of paper storage sections,
wherein paper having a larger paper size is set to be stored in a paper storage section having a longer distance to the first secondary transfer position among the plurality of paper storage sections.
